(19) United States
(12) Patent Application Publication
(10) Pub. No.: US 2016/0146179 A1
(43) Pub. Date: May 26, 2016

(54) EXTRACTION OF GRAVITATIONAL FIELD ENERGY

(71) Applicant: YANJUN CHE, TORONTO (CA)

(72) Inventor: YANJUN CHE, TORONTO (CA)

(21) Appl. No.: 14/252,778

(22) Filed: Apr. 15, 2014

(30) Foreign Application Priority Data
Apr. 16, 2013 (CA) 2814276

(51) Int. Cl. F03B 15/06; F03B 13/00

(52) U.S. Cl. CPC F03B 15/06; F03B 13/00; Y10S 74/09; F03B 17/04

(57) ABSTRACT

This invention introduces a system that enables to convert the gravitational field energy into electrical, mechanical, and/or other power form of usable energy in any location on Earth. This system utilizes the gravity force and the buoyant force in a repeated pattern to extract the gravitational field energy.

### 1. AREA OF TECHNOLOGY

This invention involves renewable clean energy. More specifically, this invention involves converting the gravitational field energy into mechanical energy. In addition, this invention also involves objects that lose the buoyancy force.

### 2. BACKGROUND OF TECHNOLOGY

Clean energies such as solar energy or wind energy are restricted by environmental conditions when outputting energy. Because of these problems, we cannot make every building or place a green energy factory; that way, not anyone would be able to generate green energy at home, in the office, and/or in the factory. The places of nuclear energy and fossil fuels cannot be taken completely. The crisis of energy shortage would not be solved completely.

There are boundless of energy source in the universe and measureless of dark matter and dark energy. Gravitational field is the result of the interactivity between dark energy and the celestial body. Matters in different places in the universe possess different kinetic energy and potential energy; gravitational field energy infiltrates into each corner of the Earth. Therefore, in recent year, people have begun to seek invisible, limitless, clean, reproducible energy and future energy—space energy (gravitational field energy).

In fact, the humankind has long been in control of the methods and techniques that relate to gravity. It has been a long history since the gravity nature is being utilized for purposes. The hydroelectric installation is one example that utilizes the gravitational potential energy of water to generate electricity. In recent years, Gravity light was invented by Clay Moulton from Virginia, United States. As the weight on the lamp drops down, it brings the rotor to rotate, the electricity caused by electromagnetic induction supports the lamp system and enables it to illuminate.

However, the gravity light functions through the gravity force; the gravitational potential energy is converted into electrical energy, and the light bulb is illuminated. The displacement of gravity force stated above is in rectilinear motion. And since the rectilinear motion is restricted by the length and cannot pursue limitlessly, and the energy converted is restricted by length, therefore the gravity force functioning in rectilinear motion cannot provide unlimited energy source.

If the gravity force is in a motion that the gravity force is able to function persistently, then without question the gravitational potential energy can persistently provide unlimited energy; In order to obtain unlimited motion in limited space, the only method is to change the rectilinear motion in gravity into rotator motion. A repeat cycle in gravity is enabled through rotation, and the potential energy is obtained. Through the motion of rotation, the gravity force is able to retreat, and the potential energy is regained, to achieve a persistent repeat cycle of gravity force function. And through this repeat cycle, the gravitational potential energy converts into kinetic energy, to achieve the purpose of persistent output of abundant energy.

In gravitational field, other than the gravity force, an opposite force also exists—the buoyant force. Essentially, the buoyant force and the gravity force both are universal gravitation. They both possess energy as they are in different places. Therefore, the buoyant potential energy and gravitational potential energy are both gravitational energy, and they are complementary as they are in opposite directions. Therefore, as the gravity force brings the movement downwards, the movement then repositions upward through the buoyant force. Using their exchange in position, the gravitational potential energy is able to retreat through the buoyant potential energy; and as the buoyant potential energy and the gravitational potential energy converts with one another, a repeat cycle of motion is formed. And through this convert cycle of buoyant potential energy and gravitational potential energy, an endless repeat of gravity force therefore produces energy output, and gravitational field energy is extracted. Therefore, the ability to process the conversion in between the gravitational potential energy and buoyant potential energy in one object is a vital factor in order to obtain gravitational energy.

However, the applied force of gravity and buoyancy are in opposite directions. Objects of greater gravity force than the buoyant force cannot rely on the buoyant force to work upwards before making a change to its volume or weight. On the contrary, as objects of lesser gravity force than buoyant force working upwards, the buoyant object cannot travel downwards relying on the gravity force. In current experiments, the gravity force and the buoyant force are only to be of unidirectional use. In current technology, there are many methods that rely on inner or outer devices to change the volume and weight of gravity force. Those are with an attempt to enable one object possess the buoyant ability and at the same time able to sink down relying on the gravity force; and eventually to solve the problem of buoyancy being both the effect of useful force and at the same time resistance. And the goal is to achieve the inter-conversion between the gravitational potential energy and the buoyant potential energy, and eventually produce energy output.

In fact, relying on internal or external device to overcome the buoyant force through changing the volume or weight for the purpose of achieving the process of downward gravity force movement, essentially, it is still a process that overcomes the buoyant force through work. In this working process, energy produced by the gravity force or the buoyant force must be consumed; and the mechanical friction resistance must be overcame and enable the gravitational potential energy and the buoyant potential energy of one same object in the process of inter-conversion, consume the energy that has already been obtained, which is the energy that, in the inter-conversion process between the gravitational potential energy and the buoyant potential energy, the energy that cannot be output. These technological methods, for extraction of celestial energy—gravitational field energy, for the purpose to fulfill the unlimited use of energy for human beings, those devices are not feasible.

Below are the examples of patents involving the conversion in the gravitational potential energy and buoyant potential energy:

U.S. Pat. No. 7,810,324 Buoyancy engine apparatus

It involves the transformation of the buoyant potential energy through functions of compression and expansion. In this invention, buoyancy resistance is required for the obstacle in the downward movement motion. The gravitational potential energy, kinetic energy, buoyant potential energy transforms into one another; therefore it does not relate to this invention.

U.S. Pat. No. 8,171,729 Mechanical output work generating apparatus incorporating buoyancy inducing

This invention requires resisting the pressure of liquid as the gravity force enters the liquid to operate the inter-conversion of gravitational potential energy and buoyant potential energy; and therefore it does not relate to this invention.

U.S. Pat. No. 7,134,283 Sealed shaft gravity buoyancy energy system and method of use thereof

This invention requires resisting the pressure of liquid as the gravity force enters the liquid to process the inter-conversion of gravitational potential energy and buoyant potential energy; and therefore it does not relate to this invention.

U.S. Pat. No. 7,735,318 Method and apparatus for using density change to create movement

It involves resisting buoyancy in the compressing and expanding form to process the inter-conversion of gravitational potential energy and buoyant potential energy. Therefore it does not relate to this invention.

U.S. Pat. No. 7,637,104 Buoyancy engine apparatus

It involves resisting the buoyant force in compressing and expanding form to process the inter-conversion of gravitational potential energy and buoyant potential energy. Therefore it does not relate to this invention.

U.S. Pat. No. 6,447,243 Buoyancy prime mover

It involves resisting buoyancy in compressing and expanding form to process the transformation exchange of gravitational potential energy and buoyant potential energy. Therefore it does not relate to this invention.

U.S. Pat. No. 8,011,182 Vertical gravity/buoyancy power generator

It involves resisting the buoyant in compressing and expanding form to process the transformation exchange of gravitational potential energy and buoyant potential energy. Therefore it does not relate to this invention.

U.S. Pat. No. 3,934,964 Gravity-actuated fluid displacement power generator

It involves resisting the buoyant force in compressing and expanding form to process the inter-conversion of gravitational potential energy and buoyant potential energy. Therefore it does not relate to this invention.

### 3. CONTENTS OF THE INVENTION

This invention introduces a system of the extraction of gravitational field energy and a method of object losing buoyancy. According to law of conservation of energy, energy conversion and concepts of fluid dynamics, the device can convert gravitational field energy that can be obtained everywhere on earth into electric energy, mechanical energy or other forms of energies.

The purpose of this invention is to provide a simple-structured and efficient method and system to extract gravitational field energy. The purpose of this invention can operate as follow: first design a type of gravitational field energy convertible device, including the carrier for the combined object and the spinning structure for the energy output device, and the combined object device installed on the spinning mechanism; the spinning mechanism is installed inside the body of a container, and the container is filled with liquid or gaseous substance. The stated combined object device obtains gravitational potential energy through the object's non-buoyant effects.

This invention has a simple structure, using the object's buoyancy resist effect or the object's buoyancy effect to enable the combined object device on one side of the spinning mechanism to acquire sinking kinetic energy, and the combined object device on the other side will acquire floating kinetic energy, and therefore the goal of efficient use of gravity force and buoyant force in order for the transducer to spin is achieved.

As opposed to current technology, this invention uses the ideal energy-exchange mode, and extract gravitational field energy in a repeated cycle, and as the object is in the liquid or gaseous substance of the gravitational field, utilizing the gravitational potential energy, the gravity force functions as though it is in the air and without any buoyant force; and in the process of sinking, it does not need to encounter with buoyancy, and therefore no energy is consumed. The addition of internal or external installation for the purpose of resisting the buoyant force by changing the object of gravity's volume or weight is even more unnecessary. The potential energy is converted into kinetic energy completely. Then the gravitational energy is used to function and generate movement of the object. After force doing work, the buoyant thrce is restored, and the buoyant potential energy is recovered. Gravitational potential energy is converted to buoyant potential energy without consuming any energy. Then by utilizing buoyant potential energy, the object move upward and do work. Potential energy is converted into kinetic energy. Gravitational energy is used to do work, and the gravity acts on the object is restored. Gravitational potential energy is recovered. Buoyant potential energy is converted to gravitational potential energy without consuming any energy. In the cycle of work and restoration of gravity and buoyant force, the unlimited resource of renewable clean energy is obtained through consist unitization of gravitational energy. This renewable energy is alternative to current available energy source including nuclear energy, fuel, solar energy, and wind energy, and it is environmental friendly.

All objects in liquid or gas are influenced by the buoyant force. Without question, in order for the gravity force to function in liquid as it is in the air and achieve sinking down movements, the buoyant force effect must be taken away. According to the principles of object losing buoyancy, the hydromechanics theory indicates that buoyancy is generated when an object is under the pressure difference of the upper and lower surface. The buoyant force is directed upwards, and therefore the direction of the pressure difference that generates the buoyant force must be upwards in order for the object to obtain buoyant kinetic energy. To achieve the goal to lose buoyancy, it is vital to achieve zero buoyancy. The key to obtain zero buoyancy is to create a pressure difference that directs downwards, and take away the buoyant kinetic energy. According to the pressure difference theory stated above, we could clearly conclude that in liquid, through using covering methods, the liquid at the lower surface of the object is covered, and the lower surface is no longer under the pressure effect of liquid; and that causes the liquid pressure of the upper surface greater than the liquid pressure of the lower surface. From this, the pressure difference directed downwards is obtained, and zero buoyancy is acquired as the buoyant kinetic energy is lost.

The method of object losing buoyancy: First, multiple objects are combined in upper and lower positions and become one object, a compound object is formed. The shape and structure of the lower object in the compound object fully shields the lower surface of the upper object; and the liquid on the lower surface of the upper object is shielded. Secondly, the gap between the upper and lower objects is closely attached or sealed to enable the lower surface of the upper object liquid free, and without the effect of liquid pressure; because, in liquid, there is liquid pressure on the upper surface of the upper object, causing the liquid pressure on the upper surface greater than the liquid pressure on the lower surface of the object; and downward pressure difference is generated. As the downward pressure difference is the opposite of the pressure difference direction produced by the buoyant force, no buoyancy is produced, and being non-buoyant, the buoyant kinetic energy is lost. The object loses buoyant effects, and possesses gravitational potential energy. At this time, the influence to the weight of the object is: as the object loses buoyancy, under the effect of the downward pressure difference and the gravitational potential energy, the object generates downward kinetic energy, in the form of sinking by the object, closely presses on the upper surface of the lower object, and at this time the gravity force is greater than the weight in the air. The experiment proves that an object can be non-buoyant in liquid and lose its buoyant effects. To distinguish with the buoyant state, such state is called non-buoyant state. Therefore, in liquid, an object can be in two different states, which are buoyant and non-buoyant states. An object under the state of non-buoyant is defined non-buoyant. Therefore the Archimedes law is no longer absolutely effective and useful.

For the establishment of the method of object losing buoyancy, its beneficial effects are: First, it forces an object not to function in buoyant effects, and for such object, regardless of whether its gravity force is greater than its buoyancy force, or its gravity force is lesser than its buoyancy force, the object is non-buoyant, and is without the buoyant kinetic energy, and the object loses the buoyant force. Second, it enables the object in liquid to possess gravitational potential energy, and therefore it obtains the ability to travel down with same effect as it is in the air. This solves the problem of having to resist the buoyant force in object. The concept of the necessity to use resources and methods to resist the obstacle of the buoyant force is changed, since in physic theory it has been common sense that the buoyant object always floats upwards. And the fixed mode is now able to change; the theory of calculating the volume and density of an object as the condition to determine its buoyancy is able to have another alternative. That gives the purpose to gain gravity force from devices new ways by using natural sources.

Gravity force and buoyant force are both conservative forces, their functioning are not related to distance but relate to the start and end positions. In the circumstance that only the gravity force and the buoyant force functions, kinetic energy and potential energy converts into one another, and the mechanical system remains unchanged. And the source of this energy is from gravitation field, and is named gravitational field energy. The functioning is by degree of the transformed energy; as the gravitational field system functions towards the outer environment, energy is transformed, and this energy is no longer from the gravitational field system. This energy becomes the source of energy for the outer environment. As gravitational energy functions through the gravitation mechanical devices, the outer mechanical system gains energy from this; the mechanical function is the accumulation of force and distance; and the process of extracting gravitational field energy is by acquiring this accumulation.

The principle of the cycle of the extraction of gravitational field energy: First, two types of several objects of the same shape volume, and weight, and the number of objects being an even number, structure a compound object applied in the method of gravity force losing the buoyant force, to enable to the object in liquid or in gaseous substances to have the following abilities: (1) the upper object is able to generate a downward pressure difference, and the buoyant force is lost, the gravity force is increased; and the object possesses gravitational potential energy. (2) When the compound object is placed inverted, the upper object in the compound object becomes the lower object and generate an upward pressure difference; being under the effect of the buoyant force, the gravity force is reduced, and the object possesses buoyant kinetic energy. Secondly, on the rotary wheel, on the stated compound object distributed in circular directions, in the same order of upper and lower positions, several combined objects are stabilized or connected in a rotary way into one object, to enable the compound objects distributed on the two sides of the wheel: on one side, the pressure difference direction of the upper object is downwards; and on the other side, the positioning of the upper and lower object in the compound object are opposite to the other side, the pressure difference direction is upwards. In the air, the weights of the compound objects on the two sides of the wheel are equal; and it is in a balanced gravity state. Then, as the rotary wheel is fixed on the base in the liquid container, the 2 sides of the rotary wheel are: On one side, the direction of the pressure difference of the compound object is upwards, and is under the effect of the buoyant force in a buoyant state, and possesses buoyant potential energy, while the gravity force is decreased. On the other side of the wheel, the compound objects' pressure difference direct downwards, and the object loses the buoyant force; it is in a non-buoyant state, at the same time it possesses gravitational potential energy and the gravity force is increased.

Since the same objects in the compound object with the equal liquid depth distributed on both sides of the revolving wheel, equal liquid pressure is applied; but their directions of pressure difference are different, and respectively they possess buoyant potential energy and gravitational potential energy, and that causes the compound objects distributed on the two sides with unequal gravity force, and that changes the previous state of balanced gravity force. The gravitational field energy enables for the compound objects respectively and oppositely process upward and downward movements, to propel the rotating wheel to rotate: when the compound object move downwards, the gravitational potential energy is converted into kinetic energy, the gravitational field energy is extracted, and the downward movement generates a displacement. The compound object also obtains the buoyant potential energy as a result of this displacement. The gravitational potential energy of the compound object converts into buoyant potential energy, the buoyant force is able to reposition. When the compound object moves upwards, the buoyant potential energy converts into kinetic energy, and the gravitational field energy is extracted. The compound object obtains gravitational potential energy because of the displacement. The buoyant potential energy of the compound object converts into gravitational potential energy. The gravity force is able to reposition. On the upper and lower part of the revolving wheel, the rotating compound object rotates its upper and lower objects backwards and the direction of the pressure difference as the compound object rotates to that place also follows with it to rotate backwards: the direction of the pressure difference transforms from a downwards into upwards. And under the effect of the buoyant force, the object possesses the buoyant potential energy and the gravity force is decreased. When the object's pressure difference direction converts from upwards into downwards, the buoyant force is lost; it is with the gravitational potential energy, and the gravity force increases. From these, through rotation, the gravity force distributed on the two sides of the wheel is still in an imbalanced state, and the wheel continues to rotate persistently. With the rotation, the gravitational potential energy and the buoyant potential energy inter-convert from one another persistently; the gravity force and the buoyant force repeatedly function in a cycle; and the extraction of gravitational field energy is in a cycle. In addition, the cycle of the extraction of gravitational field energy is indefinite; the gravity force and the buoyant force function indefinitely, and the process of the indefinite inter-conversion between the gravitational potential energy and the buoyant potential energy is as follows: the gravity force functions downwards, and the gravitational potential energy is decreased, the kinetic energy increases; in the mean time the gravitational potential energy converts into buoyant potential energy; the buoyant force functions upwards, and the buoyant potential energy decreases, the kinetic energy increases, and at the same time the buoyant potential energy converts into gravitational potential energy.

There is a high possibility that even greater energy source are from the black hole or dark energy, enabling the gravitational field to exist in the entire universe. Meanwhile, the kinetic energy in the dark energy persistently delivers and maintains the gravitational field of the whirling celestial body. Gravitational field energy, when partially taken, it is thoroughly replenished through kinetic energy; gravitational field energy is able to constantly regenerate, and this process is able to repeat infinitely. From the magnanimity of the space in the universe, the transformation of gravitational field energy is infinite; the gravitational field energy will not decrease when it is extracted; therefore, the process of the limitless extraction of gravitational field energy corresponds with the conservation of energy.

The gravitational field possesses space and energy. It is considered the king of energy source. We as human beings discover that there is plenty of energy surrounding us. Protected in the method requested in this claim, the device that obtains energy—this type of energy source possesses the following advantages:

(1) It obtains green energy anywhere and anytime on any location on Earth.
(2) The usage of this “energy source” device is not limited by time, location or environment. It can be used in any environment: Home, underground of buildings, in the sky or under the sea, and even on the Mars and the Moon.
(3) A type of simple and highly-efficient energy source device, its theoretical conversion efficiency is nearly 100%.
(4) It is a type of democratized energy source; anyone can generate power on their own.

Protected in the method requested in this claim, the device that obtains energy will be an inexhaustible energy source. This type of future-leading clean energy is free and unlimited; it will play an important role.

(1) It will redefine energy and rebuild the energy world.
(2) It will change the world, and permanently end energy-crisis. It will substitute for nuclear energy, solar energy, wind energy and fossil fuels.
(3) It will satisfy the endless need human beings have for energy. The necessity to restrict the use of energy will be put to an end.
(4) The Carbon economy will become history. The environment on Earth will be protected.
(5) The world's economy and energy strategy pattern will be changed. Industrial revolution will be initiated. The development and operation mode of the world's economy will be fundamentally influenced profoundly and lastingly.

National defenses and the military are also involved. Any civilian equipment or military equipment can be provided with everlasting force; so that mobile or portable equipments are not restricted. The device can promote guns and battle droids, unmanned aircrafts, and submarines limitlessly in any place and environment.

### 4. IN THE DIAGRAMS PROVIDED, PART OF THE INTRODUCTION IS FORMED. A THOROUGH UNDERSTANDING OF THIS INVENTION IS GIVEN AS THE DIAGRAMS AND THE DESCRIPTIONS ARE PROVIDED

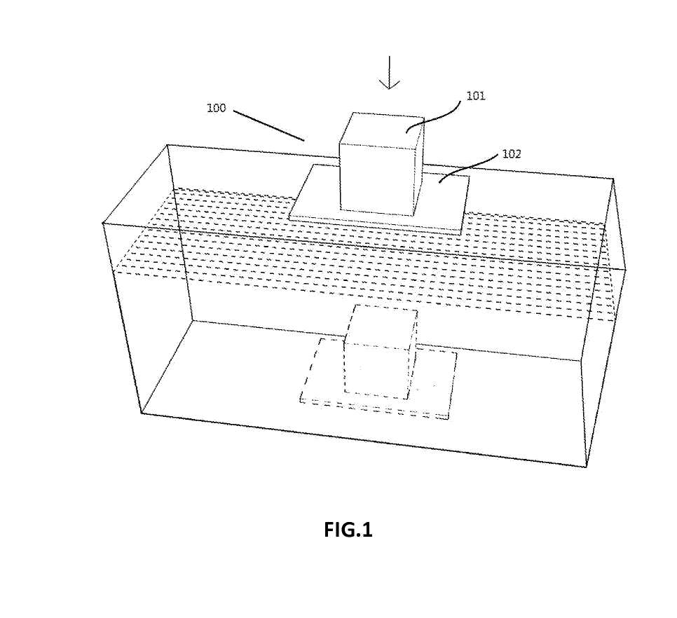

FIG. 1 is the diagram according to the first method of object losing buoyancy in this invention. The gravity force combined object 100 includes one of object 101 and one of object 102.

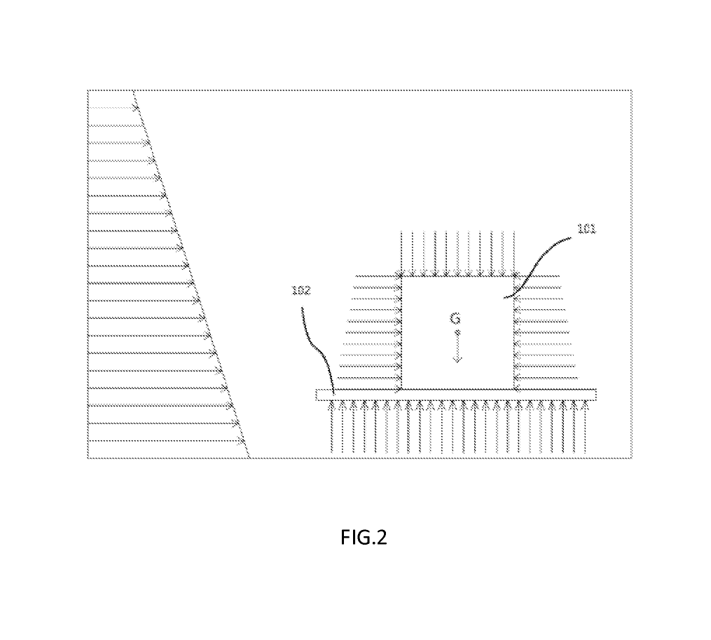

FIG. 2 is the diagram according to the embodiment FIG. 1 of this invention in which it shows the liquid pressure on object 101 and object 102.

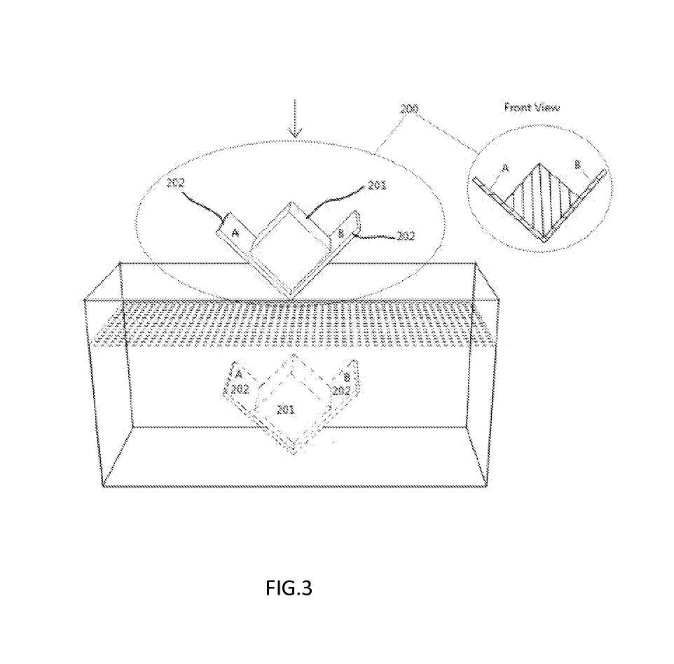

FIG. 3 is the diagram according to the second method of object losing buoyancy in this invention. The gravity force combined object 200 includes one of object 201 and one of object 202.

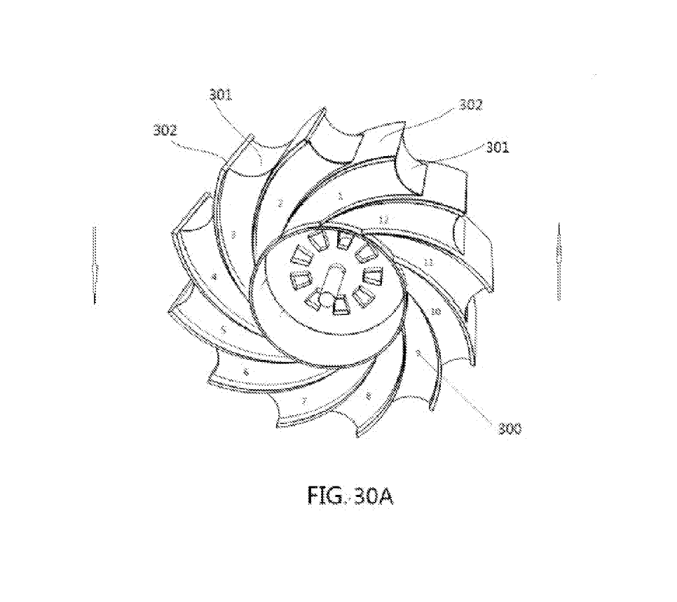

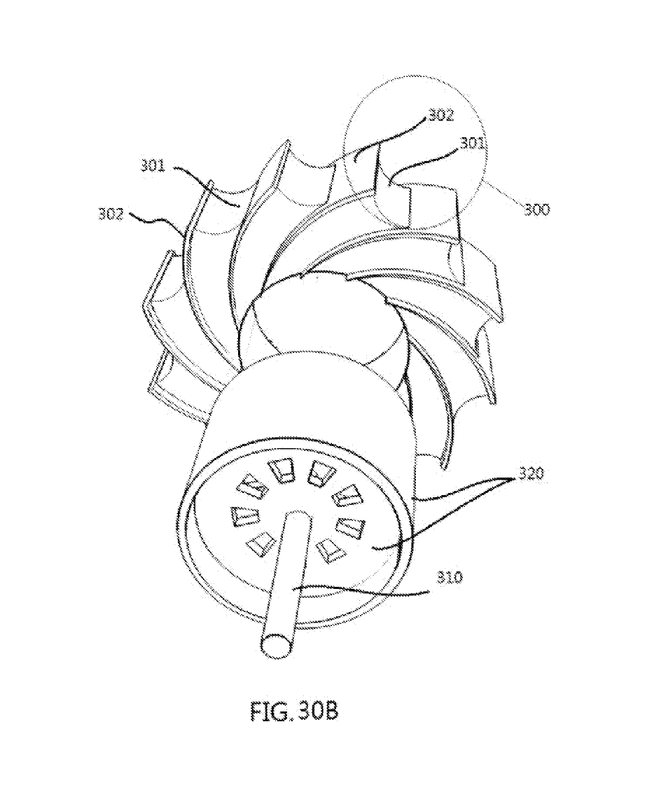

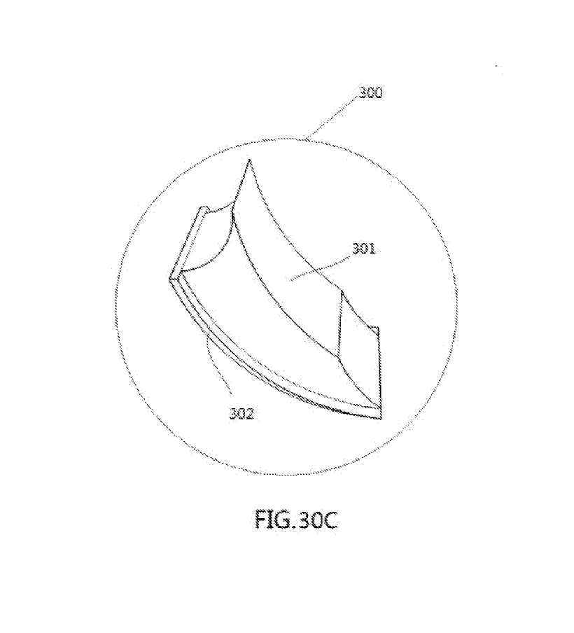

FIG. 30A is the diagram in the first embodiment according to the extraction of gravitational field energy in this invention.

FIG. 30B is the semi-diagrammatic view in the first embodiment of the extraction of gravitational field energy that shows the connections in the combined object 300, and the installment of hub 320.

FIG. 30C is the diagram in the first embodiment of the extraction of gravitational field energy in which object 301 and object 302 form a compound object—object 300.

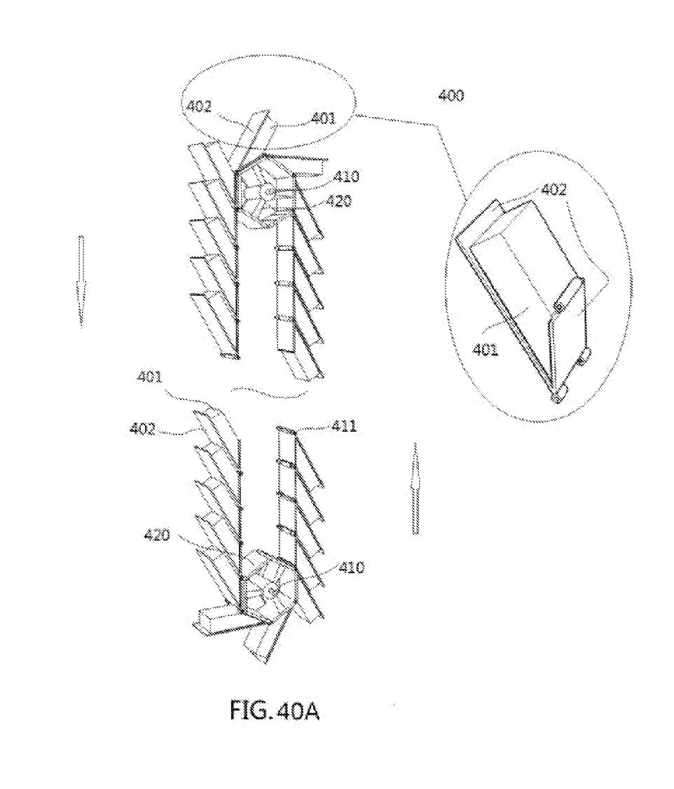

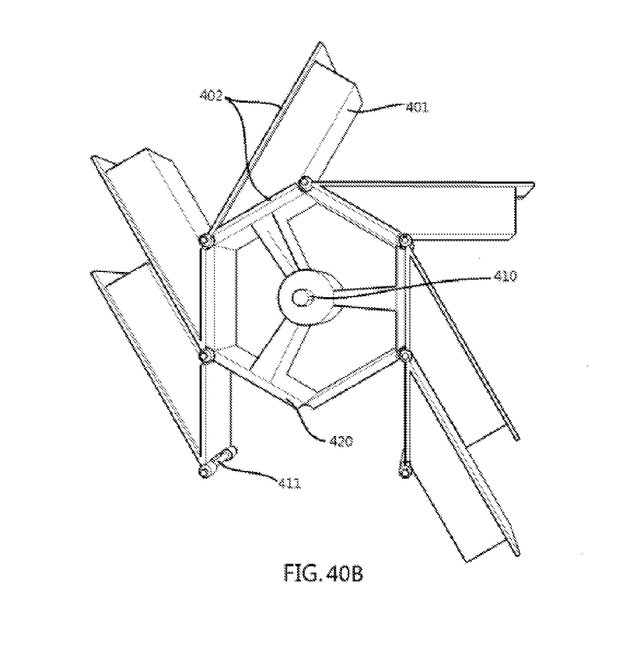

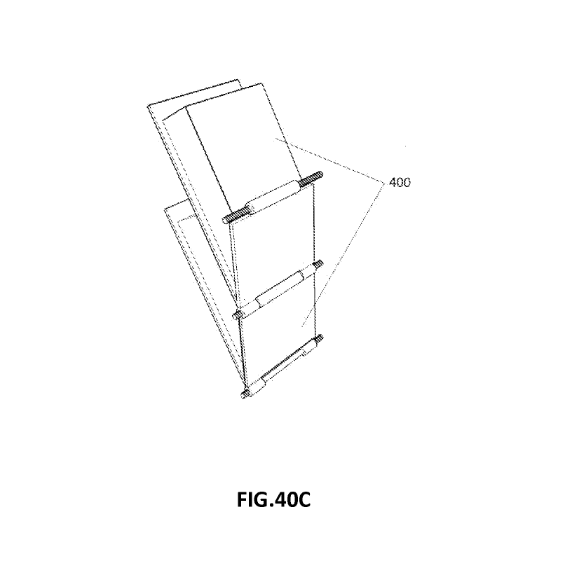

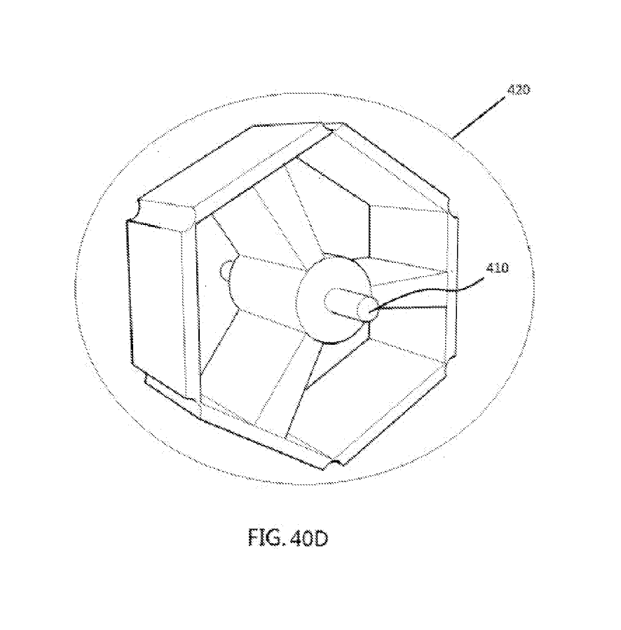

FIG. 40A is the diagram in the second embodiment according to the extraction of gravitational field energy in this invention. To make the diagram clear in view, some parts were taken out.

FIG. 40B is a semi-diagrammatic view in the second embodiment of gravitational field energy extraction in which object 401 and object 402 rotate on wheel 420.

FIG. 40C is the diagram in the second embodiment of the extraction of gravitational field energy in which the compound object 400 is connected by axis 411.

FIG. 40D is the diagram of wheel 420 in the second embodiment of gravitational field energy extraction.

This invention respectively introduces two modifications of examples of the method of object losing buoyancy and the extraction system of gravitational field energy. Although the selected embodiments of this invention have been described, to be understood that various modifications, additions and alterations can be defined by professionals in this field and make a rights claim without changing the idea and extent of this invention.

### 5. SUMMARY OF INVENTION

FIG. 1 is the first embodiment of this concept using two objects to combine into a compound object to achieve gravity loses buoyancy. In FIG. 1, the cubic object 101 and the positions above and under the flat plate object 102 combines into a compound object 100. The gravity force of object 102 is greater than its buoyant force; object 101 and object 102 are in close attached without gap. The upper surface of object 102 is greater than and also shields the lower surface of object 101. In the upper area inside the container, perpendicular to the horizontal plane, places the combined object 100. Under the effect of the gravity force, object 102 first enters the liquid, and the 4 sides and lower surface of object 102 are pressured by the liquid. And since the 4 sides of the object are of equal area and respectively symmetrical, the liquid pressures on the 4 sides are equal and also in opposite directions, and therefore the liquid pressures cancel out each other. The gravity force of object 102 is greater than its buoyant force, and that enables for object 102 to continue to sink down; as object 101 follow object 102 into the liquid, object 101 being square-shaped, its 4 sides are symmetrical and are of the same area, the liquid pressures on the 4 sides are equal and they cancel out each other as they are in opposite directions. The lower surface is shielded by object 102 and is without liquid, it is no longer under the pressure effect of liquid; the liquid pressure is zero. As the depth into the liquid increases, the downward liquid pressure on the upper surface of object 101 increases gradually. The liquid pressure on the upper surface is greater than the liquid pressure on the lower surface, therefore the liquid can only produce a downward pressure difference for object 101. And because the pressure difference is directed downwards, object 101 then is non-buoyant; it is without the buoyant kinetic energy, and is in a non-buoyant state. Therefore the gravity force loses the buoyant force. And being in the state of non-buoyant, with the downward pressure difference and the effect of gravitational potential energy, object 101 generates downward kinetic energy, and presses on top of object 102 to follow down until at the bottom of the container. When object 101 get to the bottom of the container, the direction of the pressure difference does not change; the object still remains non-buoyant and without buoyant kinetic energy. Object 101 remains losing the buoyant force; and losing buoyancy in gravity force is achieved. This embodiment proves that in the state with the buoyant force being lost, the object is only under the effect of the gravity force and it possesses gravitational potential energy. And therefore the Archimedes law is not suitable in this case.

The applicant claims that the compound objects or devices in other similar forms in which generated similar non-buoyant and buoyancy loss effects in accords to such principle have expressed in language that those compound objects or devices are able to achieve non-buoyant, lost buoyancy, with downward pressure difference, and possess gravitational potential energy. The necessary condition is that, in the compound object or device, because the lower surface of the object is shielded, the direction of the pressure difference is generated downwards.

FIG. 2 is a schematic diagram shows in the compound object 100 in the first embodiment, the stated object 101 and object 102 are pressured by liquid distribution. On the left side of the image, the horizontal arrow represents the intensity of the fluid pressure—as the depth of the liquid increases, the pressure also increases. In liquid, the upper surface of object 101 and all the side surfaces are under the pressure of liquid; there is no liquid on the lower surface of object 101. The liquid is isolated and shielded by object 102. Therefore, the liquid generates downward pressure difference towards object 101; and object 101 is non-buoyant; it is without buoyant kinetic energy; and it has lost its buoyant effects.

FIG. 3 shows the second embodiment of this concept using 2 objects to form a compound object 200 to achieve the gravity force loses buoyant force. Within, the cubic object 201 and the flat-shaped object 202 connected in right angles with greater gravity force than buoyant force combine together and form a compound object 200. Object 201 on top of object 202, stays closely in contact without gap; the 2 upper surfaces of A and B of object 202 shields the 2 lower side surfaces of object 201. In the upper area inside the container, perpendicular to the horizontal plane, places the compound object 200. Under the effect of the gravity force, the compound object 200 enters the liquid; first, the liquid generates pressure to the 2 front and back side surfaces and 2 lower surfaces of object 202; since the 4 sides of object 202 are symmetrical, and the shape and the area of the 2 sides of front and back are equal, the liquid pressure given to the sides are equal and in opposite directions, therefore they cancel out each other. And as the gravity force is greater than the buoyant force in this case, object 202 continues to sinks down perpendicularly. At the same time, object 201 enters the liquid following object 202; since object 201 is square-shaped, the two front and back sides are shaped symmetrically and are with the same area, therefore the liquid pressure on them are equal and in opposite directions; and they cancel out each other of the liquid pressure. The upward force is then not generated. The other 2 lower side surfaces are shielded by object 202 and is without liquid; it is not under the liquid pressure effect. With the liquid pressure on the lower side surfaces being zero and only the 2 upper surfaces are under the pressure effect of liquid, the pressure difference to object 201 by liquid is generated downwards. As already known that the pressure difference is directed downwards, it is non-buoyant and it is without buoyant kinetic energy, object 201 loses its buoyant force and is in a state of non-buoyant. And under the effect of the downward pressure difference and gravitational potential energy, object 201 generates downward kinetic energy and enables itself to press tightly on top of object 202 and sink down with it until at the bottom of the container. When at the bottom of the container, compound object 200 will rotate to the left or right side, and as object 201 rotates with it, the new bottom surface is also shielded by surface A or B of the object; and the pressure difference direction is still downwards; and the object is non-buoyant; it is without buoyant kinetic energy, and object 201 still loses the buoyant force.

These embodiments verify these concepts:
A type of method to lose the buoyant force by object: In liquid or gaseous substance, (a) use a compound object, such object consists of at least two objects, and the two objects are connected in one as upper and lower parts; and they are attached closely without gap or with a sealed gap. The structure of the upper surface located on the lower object isolates the liquid on the lower surface of the upper object; the upward liquid pressure on the upper object is shielded. And that enables the liquid to generate downward pressure difference to the upper object, and without buoyant force and buoyant kinetic energy, the upper object then loses buoyant effects and possesses gravitational potential energy; and (b) used on the upper object, not under the effect of the upward liquid pressure, the compound object device generates a pressure difference in the downward direction.
A type of method to lose the buoyant force in the gravity force: In liquid, (a) provide a compound object, such object consists of at least two objects, and the two objects are connected in one as upper and lower parts; and they are attached closely without gap or with a sealed gap. The structure of the upper surface located on the lower object isolates the liquid on the lower surface of the upper object; the upward liquid pressure on the upper object is shielded. And that enables the liquid to generate downward pressure difference to the upper object, and without buoyant force and buoyant kinetic energy, the upper object then loses buoyant effects and possesses gravitational potential energy; and (b) used on the upper object, not under the effect of the upward liquid pressure, the compound object device generates a pressure difference in the downward direction.
In the compound object, the area of the upper surface of the lower object is greater or equal to the area of the lower surface of the upper object.
In the compound object, the upper and lower objects are connected together in a stabilized or non-stabilized method.
The gap between the assembled objects is sealed.
In the stated combined object device, the upper object does not function under buoyant effects.
The upper or lower objects in the compound object can be comprised of multiple objects.
The direction of the pressure difference determines whether the object generates buoyant force or loses the buoyant force.
The direction of the pressure difference determines whether the object possesses buoyant potential energy or gravitational potential energy.
A type of combined object that can lead for one same object to be in a buoyant state or in a non-buoyant state in liquid or gaseous substance.
The object in which the lower surface is shielded in the compound object generates a downward pressure difference, and loses the buoyant force, and achieves the state of non-buoyant, while acquires gravitational potential energy: it is only under the effect of the gravity force. The gravity force equals to the weight in the air plus the downward liquid pressure difference.
A type of compound object in which it can lead for the liquid or gaseous substance to produce a pressure difference in a downward direction on the upper and lower surface of the object.
A type of device that can lead for one same object in liquid or gaseous substance to alternately inter-convert in between the buoyant state and non-buoyant state.
A type of device that can lead for one same object in liquid or gaseous substance to have the ability to process the inter-conversion between the upward pressure difference and downward pressure difference.
A type device that can lead for the object in liquid or gaseous substance to possess gravitational potential energy.
A compound object that is both able to gain and lose buoyancy, however the right claims are not limited to these embodiments.
A type of closed cycle system; these processes take place in such closed cycle system.
A compound object that is producible and with a pressure difference that could direct downwards, however the right claims are not limited to only these given embodiments.

FIG. 30A and FIG. 30B provides the diagram of the first embodiment of gravitational field. The device is operating in liquid. The base of the device has the main spindle 310, which is also the spindle responsible for power output. The two sides of the spindle are fixed on the base of the device by bearings. The hub 320 is fixed on main spindle 310, and the hub 320 also has twelve objects (301 and 302) of identical mass, shape, and weight. These twelve objects on the hub 320 use the method of object losing buoyancy to combine, creating the combined object 300, which is then attached to hub 320. The hub 320, with six objects of 301 on its left, and another six 301 on its right, are in opposite positions. In the air, the combined objects on hub 320's either side (combined object 300) are equal in total mass, and the gravity balanced.

When the device is operating, places the base of the device in a liquid container, then fill with liquid. The combined objects on the two sides of the spindle 300 will bear equal liquid pressure, but the five objects on the left (310) ‘2, 3, 4, 5, 6’ and the five objects on the right (301) ‘8, 9, 10, 11, 12’s pressure difference are opposite. The lower surface of the five objects 301 attached on the left side on hub 320 are covered by object 302, thus creating a downward pressure difference. The object is non buoyant, possesses gravitational potential energy, and reduces gravity. At the same time, in the same liquid depth, the left object 301's weight is greater than the right object 301, and the objects 302 on either sides are equal in weight. Hence the previous gravitational balance is destroyed, the hub 320 loses balance, the combined object 300 moves upward, the combined object 300 on the left moves downward, the hub 320 then spins, pushing the spindle 310 to spin and produces power.

On top of the hub 320, in the first object 300, object 301's pressure level changes from up to down, it is no longer buoyant, obtains potential gravitational energy, and the gravity force increases. Object 301's pressure difference changes from down to up, experiences buoyancy thus becomes buoyant, and decreases in pressure. This causes the gravitational forces on either sides of the hub 320 continue to extract unbalanced. Hub 320 continues to spin, combination object 300's gravitational force and buoyancy force continues in its conversion cycle, the gravitational field circulates, causing combination object 300 to move in reciprocal, in infinite motion. Under the circumstance of no artificial speed control, hub 320 will gradually increase in speed until the acceleration momentum and resistance come to a balance. It will cease to accelerate and output power at its maximum speed.

FIG. 40A provides the diagram of the second embodiment of gravitational field. The functions of the device are as follows: the device operates in liquid, and the base of the device has upper and lower spindles 410. The two ends of the spindle are fixed on the base by bearings, and the upper spindle 410's one side has attached an energy output wheel, which is connected by a chain to a generator. The upper and lower spindles 410 respectively have attached on a hexagonal runner 420. It is clear through the diagram that object 401 and 402 utilize a method of object losing buoyancy to create the combined object 400. Runner 420 is equipped with an even number of combined object 400. Among the side surface of every object 402 are upper and lower sleeves that are connected to form a chain through spindle 411. This chain on the runner 420 can spin and drive the main spindle 410 to output energy for the generator. In combined object 400 which is on the left chain of runner 420, each object 401's surface is covered by the upper surface side of object 402. Each object 401 can only produce downward pressure difference, lose buoyancy, possess potential gravitational energy, and increase in gravity. On the right chain of runner 420, every combined 401's lower surface is affected by the fluid, thus possess buoyancy, and decreases in gravity. When in air, the device's runner 420's left and right combined object 400 have equal weight, and are equal in gravity. When operating, secure the base of the device in a liquid container, then fill with liquid. At this time, in the same depth of liquid, object 401 on the left chain produce downward pressure difference, lose buoyancy, increase in gravity. Every object 401 on the left chain's weight is greater than the weight of every object 401 on the right chain. The objects on both sides of the chain 302 are buoyant, are equal in weight. The left chain of runner 420's total mass is greater than the right chain's total mass, thus its gravity balance is destroyed. Combined object 400 on the left chain moves downward, while the combined object 401 on the right chain moves upward. The left and right chains' combined object 400 start moving in opposite directions, pushing runner 420 to spin and produce power. Objects 401 and 402 in combined object 400 which are attached to the top of runner 420's vertical positions undergo 180 degrees reversion. Object 401's pressure difference changes from upward to downward, lose buoyancy, increase in gravity, and possess potential gravitational energy. Objects 401 and 402 in combined object 400 which are attached to the bottom of runner 420's vertical position undergo 180 reversion. When object 401's pressure difference changes from downward to upward, it experiences buoyancy, decrease in gravity, and possess potential buoyancy energy. Runner 420's chains on its left and right continue to be unbalanced, and it continues to spin. Gravity, and buoyancy reciprocating their actions. The gravitational field cycles as extracting, potential gravitational energy and buoyancy continuous transform into electricity, and can serve as a clean energy source for human use. This type of extracting device is mainly composed of:

(1) combined device that is capable of losing buoyancy
(2) Rotating mechanism
(3) Transmitting device
(4) a device that can transform output gravitational field into electricity
The fourth component can be placed and sealed within the structure or outside the liquid.

Procedures that are not explicitly described above should be common knowledge for technicians and professional personnel. It is understood that the above descriptions of the quantity of rotating wheels, the combined objects' shape and distribution of form, method of seal, and debugging techniques can be largely altered, while still being part of the invention.

Although the invention has given embodiments and details that have specific representations, however professionals working in this field can simply make changes to the methods and devices published in this invention and without altering the invention. The extent within this invention is defined by the rights given.

These embodiments verify these concepts:
The method of extracting gravitational field energy: In liquid or gaseous substance, (a) use a rotating device described above, the wheel on the axis of the device has a compound object consists of a set of objects of equal shape, volume and weight, and the quantity being an even number (in the application of the stated method of losing the buoyant force in the gravity force) And the stated compound object follows the same direction of the pressure difference as losing the buoyant force, and rotates or stabilizes to connect into a circle or chain to enable the wheel of the stated rotating device: distributed on one side, the lower surface of the upper object is shielded, and the compound object's pressure difference direction is downwards. And the buoyant force is lost; the object possesses gravitational potential energy, and does sinking movements. On the other side the upper and lower part of the compound object distributed are opposite to the opposite side, the direction of the pressure difference is upwards: and under the effect of the buoyant force, it possesses the buoyant potential energy, and does buoyant movements; the gravity force is reduced. From this, the balanced gravity force state of the 2 sides of the wheel in the air is altered; a cycle of rotation is pushed out, and through the axis of the stated device, energy force is given out, the gravitational field energy is extracted; In addition, (b) used in an object in process of the inter-conversion cycle in between the state of buoyant and non-buoyant, the device extracts gravitational field energy.
The method of extracting gravitational field energy: In liquid or gaseous substance, (a) provide a rotating device described above, the wheel on the axis of the device has a compound object consists of a set of objects of equal shape, volume and weight, and the quantity being an even number (in the application of the stated method of losing the buoyant force in the gravity force) And the stated compound object follows the same direction of the pressure difference as losing the buoyant force, and rotates or stabilizes to connect into a circle or chain to enable the wheel of the stated rotating device: distributed on one side, the lower surface of the upper object is shielded, and the compound object's pressure difference direction is downwards. And the buoyant force is lost; the object possesses gravitational potential energy, and does sinking movements. On the other side the upper and lower part of the compound object distributed are opposite to the opposite side, the direction of the pressure difference is upwards; and under the effect of the buoyant force, it possesses the buoyant potential energy, and does buoyant movements; the gravity force is reduced. From this, the balanced gravity force state of the 2 sides of the wheel in the air is altered; a cycle of rotation is pushed out, and through the axis of the stated device, energy force is given out, the gravitational field energy is extracted; In addition, (b) used in an object in process of the inter-conversion cycle in between the state of buoyant and non-buoyant, the device extracts gravitational field energy.
The joints between the compound objects can be connected in fixed joints or rotatable joints.
The object converts from buoyant state into non-buoyant movement state, and is with gravitational potential energy, and does downward movements.
The object converts from non-buoyant state into buoyant movement state, and is with buoyant potential energy, and does upward movements.
The inter-conversion between the gravitational potential energy and buoyant potential energy generates gravitational field energy.
The buoyant state and the non-buoyant state of the object form a repeated cycle of inter-conversion; the extraction of gravitational field energy is in a repeated cycle.
A device used for the repeated functioning of the gravity force and buoyant force. A type of device that will be able to obtain gravitational field energy from any place on Earth and part of that energy convert into heat, electrical and mechanical type of energy or any other type of energy in power form.
The stated combined object device's characteristics consist of acquiring gravitational potential energy through buoyancy-resist object.

The stated combined object's characteristics depend on the object in the stated combined object not to be under the effect of buoyancy.

The stated gravitational field energy extraction system's characteristics are determined by the connection of the stated combined object device being in a circle.

The stated combined object device's characteristics are determined by the volume of the stated combined object device to remain unchanged.

The stated energy extraction system requires outputting energy by utilizing the buoyant potential energy and the gravitational potential energy of the combined object devices.

Structure and form that is producible and functional. However the right claims are not limited to these given embodiments.

1. A type of method and installation to lose buoyancy—its characteristics are based on: including, in liquid or gaseous substance, (i) a combined object that is composed of at least 2 objects that are closely attached together to unitize as one (a) on the stated combined object, the lower surface and side lower surface of the upper object are covered by the lower object, (b) the stated upper object is disenabled from the effect of upward liquid pressure, (c) the liquid generates downward pressure difference toward the upper and lower surface of the object, and (ii) the device leads for the object to generate a downward direction of pressure difference.

2. The gravitational field energy extraction system, includes the supporting body of the combined object device and the rotating structure of the energy output device, and the combined object device installed on the rotating structure; the rotating structure is installed inside a container, and the container is filled with liquid or gaseous substance; it is characterized by: the stated combined object device obtains gravitational potential energy through the object being under no buoyancy effects.

3. Method of extraction of gravitational field energy and installation—its characteristics are based on: includes, in liquid or gas,
(i) on the perpendicular rotating device are several combined objects of the same shape, weight and direction, structured in application of the method of losing the buoyant force in the gravity force; and
(ii) the liquid pressure enables for:
(a) On each combined object distributed on one side of the stated device, the lower and upper surfaces of the upper object generate downward pressure difference direction and lose the buoyant force, and that leads for the combined object to gain gravity force;
(b) and on each combined object distributed on the other side of the stated device, the lower and upper surfaces generate an upward pressure difference direction and acquire buoyancy, leading for the combined object to reduce its gravity force; that causes the stated rotating device being: the total gravity force on one side of the stated combined object is greater than the total gravity force on the other side of the stated combined object; therefore the balance of the gravity force of the two sides (left and right) of the stated rotating device is disturbed, making the combined object on the left side continuously function to sink down, enabling for the combined object on the right side keep function to float up, causing the stated rotating device to rotate in a cycle and give out gravitational field energy; and
(iii) device used for extracting gravitational field energy through the cycle of the inter-conversion process in between the buoyant state and non-buoyant state.
A structure of which contains the stated combined object, within it contains in liquid or gaseous substances, certain appointed routine of device used for the stated combined object to function according to the appointed routine.

4. According to claim 1, the characteristics are based on—in the combined object, the connection between the upper object and the lower object is fixed and the gap in between is also closely sealed.

5. According to claim 1, the characteristics are based on, within the stated combined object, the upper object does not function under buoyancy effects.

6. According to claim 3, its characteristics are based on, the stated combined object rotate upwards and downwards along the fixed path; and the stated upper object and lower object exchange between upward and downward positions.

7. According to claim 1, the structure of the objects is defined as, wherein, in liquid, the stated upper object loses its buoyancy force.

8. According to claim 1, its characteristics are based on—in the combined object, a device in which the upper object is pressured by one direction causing weight increase.

9. According to the stated gravitational field energy extraction system in claim 3, wherein,
(a) Defining at least 1 combined object structured in the application of losing buoyancy by gravity; within, the liquid or gas generates a downward pressure difference towards the upper object in the stated combined object; and it is without buoyant force and/or buoyant potential energy; and it also enables the object to generates the ability to travel down, and the gravity force of the stated combined object increases.
(b) A structure in which it includes one or more revolving device, on the axle in the stated revolving device is the power take-off shaft, it is characterized by: on both sides of the stated revolving device, several stated combined objects are installed.
(c) On the stated revolving device, the chain or circle connected by the front and end of the combined object, its characteristics are: (i) distributed on one side of the stated rotating device in the stated combined object, the lower surface of the upper object is covered, and a downward pressure difference is generated, and the buoyant force is lost while possessing gravitational potential energy, and the gravity force of the stated combined object is increased; and (ii) the upper and lower surface of the stated combined object distributed on the other side of the stated rotating device generate an upward pressure difference and therefore generate buoyant force; and it possesses gravitational potential energy, the weight is reduced, therefore (iii) the gravity balance of the left and right sides of the chain or circle of the rotating device in the air is disturbed, and the gravitational potential energy is transformed into kinetic energy, and pushes (iv) the stated rotating device rotate persistently;
(d) The power take-off wheel of the stated revolving device is characterized by: converting the acquired gravitational field energy into usable energy such as electric, mechanical or other forms of kinetic energy through outputting or connecting engines through transmission chain.

10. According to claim 8, wherein all of the stated combined objects are fixed in connection or rotatable in connection.

11. According to claim 2, the characteristics are based on, in liquid, a device is used for the interchange of movements between the gravity force and buoyant force; a device that is able to convert a part of the gravitational field energy acquired anywhere on Earth into thermal, electric, mechanical or other forms of usable energy.

12. According to claim 3, the characteristics are based on:
(i) the stated object transforms from a non-buoyant state to a buoyant state, it has gravitational potential energy, and performs upward movements.
(ii) Within, the stated combined object converts from the buoyant state to non-buoyant state, is with gravitational potential energy, and performs downward movements.

13. According to the gravitational field energy extraction system stated in claim 3, wherein the stated combined object constantly operate a cycle of converting from a buoyant state to a non-buoyant state.

14. According to claim 3, wherein the stated combined object constantly generate pressure differences of downward direction and upward direction.

15. According to claim 2, the characteristics are based on—the stated object gives out kinetic energy in the process of its inter-conversion between the buoyant potential energy and gravitational potential energy.

16. According to claim 2, wherein on the two sides (left and right) of the stated revolving device, the stated combined object respectively performs upward and downward opposite rotating movements.

17. According to the gravitational field energy extraction system in claim 3, it is characterized by,
a) A method of which includes: providing at least one defined combined object, (i) the combined object is composed of at least two objects connected as in upper and lower object positions, and closely attached without gap and sealed in between, and (ii) the structure of the upper surface of the lower object covers the lower surface of the upper object.
b) A system of which includes: (i) defines at least one structure of a mechanism, within, as the stated mechanism acquire gravitational field energy in a liquid or gas environment, the stated combined objects on the left and right two sides of the rotating device are of unequal gravity force; (ii) the pressure difference of the upper and lower surface of the stated objects on the left and right sides of the stated rotating device are in opposite directions; (iii) respectively possess gravitational potential energy and buoyant potential energy.

18. According to the gravitational field energy extraction system stated in claim 2, wherein the upper and lower surface of the combined object generate a downward pressure difference.

19. According to the gravitational field energy extraction system stated in claim 2, it is characterized by—the object constantly switch from the buoyant state to non-buoyant state.

20. According to the gravitational field energy extraction system stated in claim 2, wherein, the stated object forms a cycle operating between generating a downward pressure difference and an upward pressure difference.

21. According to the gravitational field energy extraction system stated in claim 2, wherein the combined object is able to obtain gravitational potential energy and buoyant potential energy.

22. According to claim 1, wherein, within the stated combined object, the lower object contains the lower surface and lower side of the upper object.

23. According to claim 2, the stated gravitational field energy extraction system, it is characterized by, obtaining gravitational potential energy through object(s) that does not function under buoyancy effects.

24. According to claim 1, in the stated combined object, wherein the object in the stated combined object device does not function under buoyancy effects.

25. According to claim 3, of the stated gravitational field energy extraction system, it is characterized by the connection of the stated combined object device being in a circle.

26. According to claim 1, of the stated combined object device, it is characterized by that the volume of the stated combined object device remain unchanged.

27. According to claim 2, in the stated energy extraction system, it is characterized by outputting energy by utilizing the buoyant potential energy and the gravitational potential energy of the combined object devices.

28. According to claim 1, in the stated combined object device, it is characterized by a combined object of which its buoyancy is producible and losable; nevertheless the claims are not limited to these specially appointed implementations.
